(19) United States
(12) Patent Application Publication
(10) Pub. No.: US 2002/0099801 A1
(43) Pub. Date: Jul. 25, 2002

(54) Data transmission-reception system and data transmission-reception method

(76) Inventor: Miruka Ishii, Tokyo (JP)

Correspondence Address: FROMMER LAWRENCE & HAUG LLP, 745 FIFTH AVENUE, NEW YORK, NY, 10151, US

(21) Appl. No.: 10/038,186

(22) Filed: Oct. 24, 2001

(30) Foreign Application Priority Data
Oct. 25, 2000 (JP) 2000-326116

(51) Int. Cl. G06F 15/16

(52) U.S. Cl. 709/219

(57) ABSTRACT

A data communication system includes: first terminal devices for transmitting first contents and IDs of information providers providing the first contents; a server device for receiving the first contents and the information provider IDs from the first terminal devices and for storing the received first contents and information provider IDs onto a storing element; and second terminal devices which display on a displaying element information provider information including at least the first contents and the information provider IDs transmitted from the server device, which allow users to select desired items of the information provider information displayed on the displaying element, and which transmit to the server device information provider IDs corresponding to the user-selected items of the information provider information, along with user IDs. The server device transmits to the first terminal devices request data corresponding to the information provider IDs sent from the second terminal devices. The first terminal devices transmit second contents corresponding to the request data to the server device. The server device transmits the second contents to the second terminal devices corresponding to the user IDs.

### BACKGROUND OF THE INVENTION

The present invention relates to a data transmission-reception system and a data transmission-reception method for allowing viewers to request artists to produce music or other contents on the viewers' behalf using a network such as the Internet.

Most viewers in the general public have few personal contacts with artists and thus have few opportunities to ask them to write, say, original pieces of music on the viewers' behalf. Even if a viewer using influential contacts wants to commission an artist or artists to produce music or other contents, the artists are often barred from accepting the commission because they are bound by contracts with record companies they belong to. Under these circumstances, it is extremely difficult for viewers to request artists (especially their favorites) to produce music to the viewers' liking.

The present invention has been made in view of the above circumstances and has as its principal object the provision of a novel system and method for data transmission and reception for allowing viewers easily to request favorite artists to produce music or other contents on the viewers' behalf by use of a network such as the Internet.

Another object of this invention is to provide a data transmission-reception system and a data transmission-reception method for allowing viewers to listen to or otherwise try samplers offered by artists so that the viewers may eventually select their favorite artists and commission them to produce contents on the viewers' behalf illustratively using the Internet.

A further object of this invention is to provide a data transmission-reception system and a data transmission-reception method for allowing viewers to ask artists to produce contents based on the viewers' specific requests addressed to the artists.

An even further object of this invention is to provide a server device and a data processing terminal device for use with the data transmission-reception system according to the invention.

### SUMMARY OF THE INVENTION

In carrying out the invention and according to one aspect thereof, there is provided a data communication system including: first terminal devices for transmitting first contents and IDs of information providers providing the first contents; a server device for receiving the first contents and the information provider IDs from the first terminal devices and for storing the received first contents and information provider IDs onto a storing element; and second terminal devices which display on a displaying element information provider information including at least the first contents and the information provider IDs transmitted from the server device, which allow users to select desired items of the information provider information displayed on the displaying element, and which transmit to the server device information provider IDs corresponding to the user-selected items of the information provider information, along with user IDs of the users; wherein the server device transmits to the first terminal devices request data corresponding to the information provider IDs sent from the second terminal devices; wherein the first terminal devices transmit second contents corresponding to the request data to the server device; and wherein the server device transmits the second contents to the second terminal devices corresponding to the user IDs.

According to another aspect of the invention, there is provided a server device including: a communicating element for communicating with first terminal devices of information providers providing first contents, and with second terminal devices of users requesting the information providers to produce second contents; a storing element for storing the first contents and IDs of the information providers transmitted from the first terminal devices; and a controlling element for causing the communicating element, to transmit to the second terminal devices information provider information including the first contents and the information provider IDs received from the first terminal devices; to receive information provider IDs selected by users of the second terminal devices along with user IDs of the users; to transmit request data to the first terminal devices corresponding to the selected information provider IDs; to receive from the first terminal devices more second contents corresponding to the request data; and to transmit the second contents to the second terminal devices corresponding to the user IDs.

According to a further aspect of the invention, there is provided an information processing terminal device including: a storing element for storing first contents and information provider IDs; a communicating element for transmitting the first contents and the information provider IDs from the storing element to a server device; and a controlling element for causing the communicating element, to receive via the server device request data from other information processing terminal devices identified by information provider IDs sent from the other information processing terminal devices; and to transmit to the server device second contents corresponding to the request data.

According to an even further aspect of the invention, there is provided an information processing terminal device including: a displaying element for displaying information provider information sent from a server device, the information provider information including at least first contents and IDs of information providers providing the first contents; a selecting element for allowing users to select at least one item of the information provider information displayed on the displaying element; a communicating element for transmitting to the server device request data including information provider IDs corresponding to the items of the information provider information which are selected by users through the selecting element, along with user IDs of the users; and a controlling element for causing the communicating element to receive from the server device second contents corresponding to the request data.

Other objects, features and advantages of the invention will become more apparent upon a reading of the following description and appended drawings.

### BRIEF DESCRIPTION OF THE DRAWINGS

FIG. 1 is a block diagram showing a typical structure of a data transmission-reception system according to the invention;

FIG. 2 is a flowchart of steps in which an audition is carried out;

FIG. 3 is a tabular view of a website page announcing an audition to artists;

FIG. 4 is a tabular view showing how successful entrants of the audition are disclosed;

FIG. 5 is a flowchart of steps in which to determine fees to be paid to artists;

FIG. 6 is a flowchart of steps in which a viewer requests an artist or artists to produce a piece of music on the viewer's behalf;

FIG. 7 is a tabular view showing how fees to be paid to artists are typically set;

FIG. 8 is an explanatory view depicting steps from the time a viewer-commissions an artist or artists to produce a piece of music until the completed piece of music is delivered to the viewer;

FIG. 9 is a tabular view indicating how fees are estimated for a plurality of artists commissioned by a viewer to produce a piece of music;

FIG. 10 is a tabular view showing how the fee is estimated for a single artist commissioned by a viewer to produce a piece of music;

FIG. 11 is a schematic view of a musical piece production request slip into which a viewer makes entries when requesting an artist or artists to produce a piece of music on the viewer's behalf;

FIG. 12 is a flowchart of steps in which a viewer requests an artist or artists to modify the delivered music data; and

FIG. 13 is a flowchart of steps in which to settle fees.

### DESCRIPTION OF THE PREFERRED EMBODIMENTS

A data transmission-reception system embodying the invention will now be described with reference to the accompanying drawings. This is a system that allows any viewer browsing a website of the system to test-listen to works by artists posted on that website and to select accordingly a preferred artist or artists who are then commissioned to produce an original piece of music to the viewer's liking.

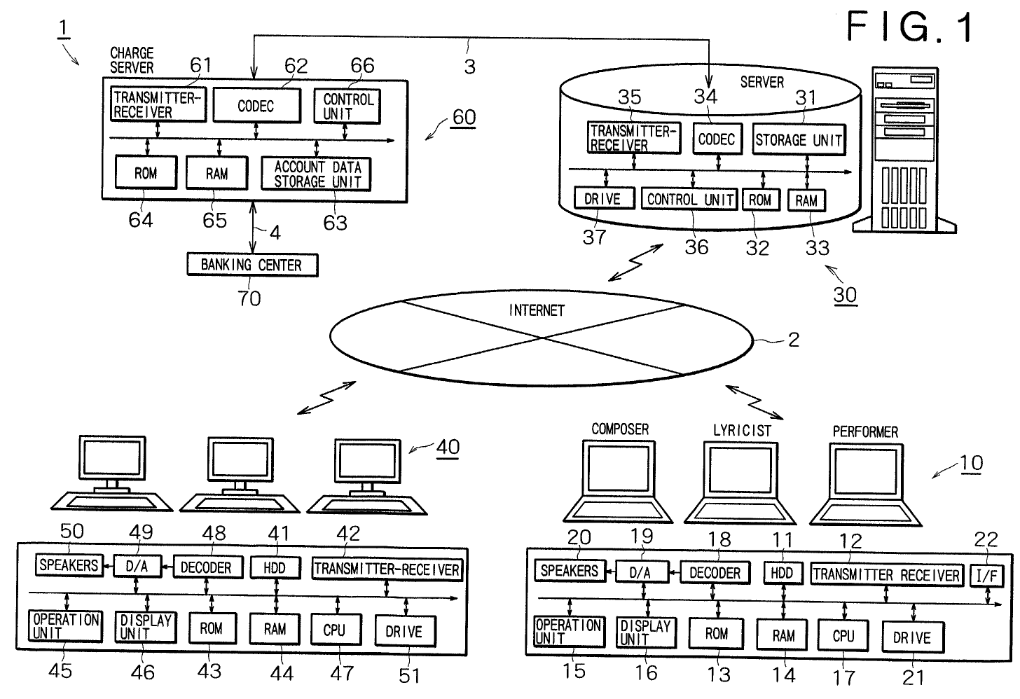

FIG. 1 is a block diagram showing a typical structure of the data transmission-reception system 1 according to the invention. As illustrated in FIG. 1, the inventive system 1 comprises artists' terminal devices 10 installed at the places of artists such as performers and composers; a server device 30 to which data representative of lyrics, melodies, whole pieces of music and the like are uploaded from the artists' terminal devices 10; and viewers' terminal devices 40 from which viewers gain access to the server device 30 to select some of the artists and to request them to produce music data and the like to the viewers' taste. The artists' terminal devices 10 and viewers' terminal devices 40 are connected to the server device 30 of an Internet service provider over the Internet 2 via telecommunication lines such as ISDN (Integrated Services Digital Network) lines or CATV (cable television) lines.

The artists' terminal devices 10, each regarded as a first terminal device in the context of this invention, are installed at the places of lyricists who write lyrics for songs, of composers who compose melodies for lyrics, of performers who play or sing pieces of music written by lyricists and composers, and of lyricist-composer-performers who do all these activities by themselves. Each artist's terminal device 10 includes a hard disc drive (HDD) 11 that stores music-related contents such as lyrics, melodies and whole pieces of music, as well as application programs such as a music production support program, a browser program for browsing websites, and an e-mail program; a transmitter-receiver 12 that sends and receives data to and from the server device 30; a read-only memory (ROM) 13 that retains control programs and other resources for controlling overall operations; a random-access memory (RAM) 14 that temporarily accommodates the control programs and others read from the ROM 13; an operation unit 15 including a keyboard and a mouse; a display unit 16 for displaying website pages upon access to the server device 30; and a central processing unit (CPU) 17 that controls the whole terminal function.

The artist's terminal device 10 further includes a decoder 18 that decodes illustratively music data held on the HDD 11; a digital-analog (D/A) converter 19 that converts the decoded music data from digital to analog format; and speakers 20 for outputting the music data converted to analog signals. In addition, the artist's terminal device 10 includes a drive 21 that drives an external storage unit loaded with such a storage medium as an optical disc (read-only or writable), a magneto-optical disc, or an IC card accommodating a semiconductor memory; and an interface 22 to which an external device such as an electronic musical instrument is connected.

At the artist's terminal device 10 of the above-described constitution, an artist enters a start command through the operation unit 15 to start a desired application program from the HDD 11. The entered start command causes the CPU 17 to read the necessary programs from the HDD 11 and ROM 13 into the RAM 14 for execution.

Illustratively, when writing lyrics or composing melodies for lyrics, the artist starts the music production support program mentioned above. Operating on the keyboard and/or mouse constituting the operation unit 15 allows the artist to have the music production support program and related resources executed by the CPU 17. This assists the artist in writing lyrics or composing melodies more easily. The lyric or melody data are recorded onto the HDD 11. When performing music, the artist connects an electronic musical instrument to the interface 22. Playing on the instrument causes performance data to be entered through the artist's terminal device for storage onto the HDD 11.

When reproducing whole-music data or performance data based on melody data from the HDD 11, the artist operates the operation unit 15 to get a relevant whole-music data file or performance data file decoded by the decoder 18. The decoded data are converted to analog signals by the D/A converter 19 for acoustic output through the speakers 20.

The artist's terminal device 10 may be used to browse website pages established on the server device 30 and to upload lyric, melody or whole-music data to the server device 30. Illustratively, when browsing a website set up by the server device 30, the artist enters through the operation unit 15 a URL (Uniform Resource Locator) indicative of where the website in question is located. Entering the URL executes the corresponding transmission protocols such as TCP/IP (Transmission Control Protocol/Internet Protocol). This allows the artist's terminal device 10 to access the server device 30 via the Internet 2 and to display the website pages of interest on the display unit 16.

The artist's terminal device 10 is capable of uploading contents such as lyrics, melodies, performances or whole pieces of music produced by the artist. More specifically, the relevant URL is first input through the operation unit 15, which executes relevant protocols such as TCP/IP causing the data to be uploaded to the server device 30.

Where an application program is to be installed from an external storage unit, an installation command is entered through the operation unit 15 of the artist's terminal device 10. The entered command causes the CPU 17 to read the desired application program from the drive 21 connected to the external storage unit and to install the program onto the HDD 11. If the external storage unit has music data or other contents stored thereon, connecting the device to the drive 21 allows the content data to be copied from the device onto the HDD 11 of the artist's terminal device 10.

The server device 30, to which contents are uploaded from the artists' terminal devices 10 as described, has a structure similar to that of common computers as depicted in FIG. 1. That is, the server device 30 includes a storage unit 31 that retains website pages and other resources; a ROM 32 that contains control programs for controlling overall operations and the like; a RAM 33 to which data are read temporarily from the ROM 32 or other locations; a CODEC 34 that encodes and decodes data; a transmitter-receiver 35 that sends and receives data to and from the artists' terminal devices 10 and viewers' terminal devices 40; a control unit 36 that controls overall operations based on the programs retrieved from the ROM 32 or other locations; and a drive 37 for installing application programs and other resources into the storage unit 31.

The server device 30 offers a website at which artists may disclose contents such as whole-music data uploaded from their terminal devices 10. Any viewer who browses the website may select one or more artists according to the disclosed contents and may commission the selected artists to produce an original piece of music to the viewer's liking. More specifically, the website gives an audition to artists who wish to have their services employed for a fee by viewers. Viewers may test-listen to works by the artists who have been accepted at the audition and may select accordingly a preferred artist or artists to be commissioned to produce pieces of music to the viewers' taste.

The audition is held by executing illustratively an application program that is to be installed from an external storage unit attached to the server device 30. Specifically, the control unit 36 retrieves the application program in question from the drive 37 to which the external storage unit is connected, and installs the retrieved program illustratively into the storage unit 31.

The viewer's terminal device 40 is used by each viewer to browse the website established by the server device 30 and to commission artists to produce music contents. As shown in FIG. 1, the viewer's terminal device 40 is constituted illustratively by a personal computer set up in an individual's household. The viewer's terminal device 40 includes a hard disc drive (HDD) 41 that stores application programs such as a browser program for browsing websites and an e-mail program as well as music-related data; a transmitter-receiver 42 for sending and receiving data to and from the server device 30; a ROM 43 that retains control programs and other resources for controlling overall operations; a RAM 44 that temporarily accommodates the control programs and others read from the ROM 43; an operation unit 45 including a keyboard and a mouse; a display unit 46 for displaying website pages upon access to the server device 30; and a CPU 47 that controls the whole terminal function based on the programs from the HDD 41 and ROM 43.

The viewer's terminal device 40 further comprises a decoder 48 that decodes data such as whole-music data and performance data downloaded illustratively from the server device 30; a D/A converter 49 that converts the decoded music data from digital to analog format; and speakers 50 for outputting the music data converted to analog signals. In addition, the viewer's terminal device 40 includes a drive 51 that drives an external storage unit loaded with such a storage medium as an optical disc (read-only or writable), a magneto-optical disc, or an IC card accommodating a semiconductor memory.

The viewer's terminal device 40 of the above-described constitution may be used to browse website pages established on the server device 30 and to download contents such as lyric, melody or whole-music data of preferred artists from the server device 30. Illustratively, when browsing a website set up by the server device 30, the viewer enters through the operation unit 45 a URL indicative of where the website in question is located. Entering the URL executes the corresponding transmission protocols such as TCP/IP (Transmission Control Protocol/Internet Protocol). This allows the viewer's terminal device 40 to access the server device 30 via the Internet 2 and to display the website pages of interest on the display unit 46. When downloading illustratively whole-music data of a favorite artist or artists after browsing the website, the viewer enters a download start command through the operation unit 45. The entered command is transmitted to the server device 30 from which the desired data are in turn downloaded to the viewer's terminal device 40 for storage onto the HDD 41.

When reproducing the downloaded music data from the HDD 41, the viewer operates the operation unit 45 to get the relevant music data file decoded by the decoder 48. The decoded data are converted to analog signals by the D/A converter 49 for acoustic output through the speakers 50. This allows the viewer to test-listen to the downloaded pieces of music for comparison before selecting a preferred artist or artists who are then commissioned to produce an original piece of music to the viewer's liking.

Where an application program is to be installed from an external storage unit, an installation command is entered through the operation unit 45 of the viewer's terminal device 40. The entered command causes the CPU 47 to read the desired application program from the drive 51 connected to the external storage unit and to install the program onto the HDD 41.

The inventive data transmitter-receiver system 1 further includes a charge server device 60 that allows viewers to settle fees charged for the pieces of music that artists are commissioned to produce. As shown in FIG. 1, the charge server device 60 is connected both to the server device 30 via a leased line 3 and to a banking center 70 via a leased line 4. The charge server device 60 includes a transmitter receiver 61, a CODEC 62 that encodes and decodes data, a storage unit 63 that retains management data about artists' and viewers' bank accounts and the like, a ROM 64 that contains control programs for controlling overall operations; a RAM 65 to which programs are loaded from the ROM 64, and a control unit 66 that controls the whole server function.

When an artist enters for an audition from the artist's terminal device 10, the charge server device 60 settles the entry fee by updating the artist's bank account data. When a viewer requests an artist or artists to produce a piece of music through the viewer's terminal device 40, the charge server device 60 settles the fees involved by updating the viewer's and the artists' bank account data.

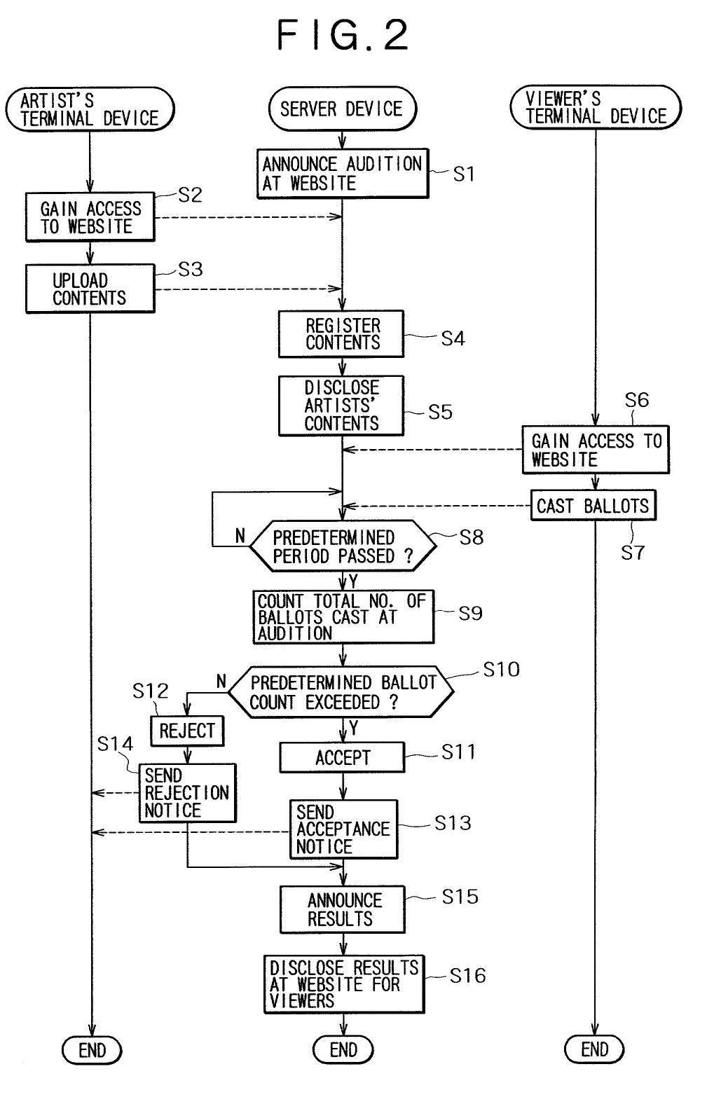

Described below with reference to FIG. 2 is how an artist may enter illustratively for an audition bringing along his or her music contents through the use of the data transmission-reception system of the above-described constitution.

In step S1 of FIG. 2, the server device 30 announces on its website an audition to artists who may be commissioned by viewers to produce pieces of music in the latter's behalf. In soliciting candidates, the website discloses ways to enter for the audition. Specifically, there are four categories to apply for: lyricists, composers, performers, and lyricist-composer-performers. Also announced are the time limit for application and entry fees. The website further indicates that viewers will cast ballots during a predetermined period for favorite artists among those posted. Illustratively, the audition may, for evaluation purposes, present specific themes for the applicants to take on in their respective categories. For example, the audition may present “the sea” as the theme to lyricists; “bossa nova” to composers; a set piece to performers; and “the sea,” “bossa nova” and the set piece for lyricist-composer-performers who are subject to overall evaluation.

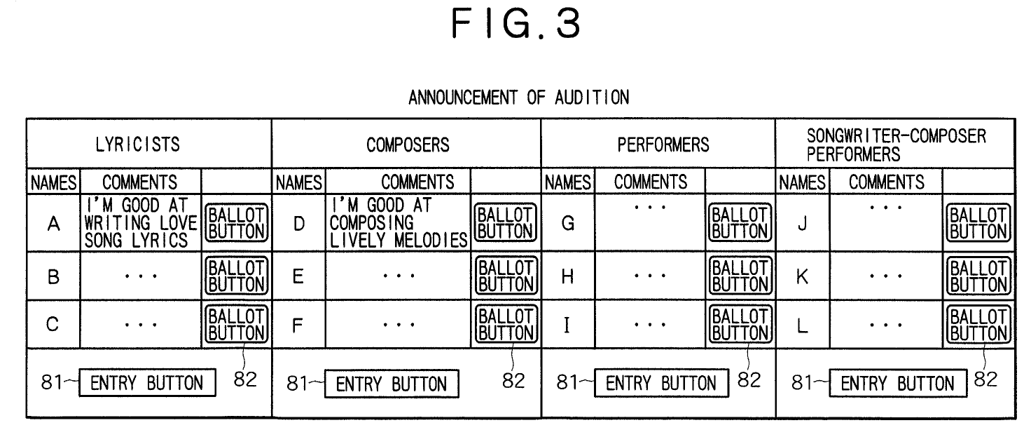

In step S2, each artist at the artist's terminal device 10 operates the operation unit 15 to specify the appropriate URL to access the website. The artist's terminal device 10 in turn downloads the website pages for display on the display unit 16. As shown in FIG. 3, the website exhibits the names or pen names of the artists who have entered for the different categories, together with their comments and sampler contents representative of their works.

An artist who wants to enter for the audition operates the operation unit 15 to click on an entry button 81 of the desired category in step S3. The click on the button 81 causes the artist's terminal device 10 to upload to the server device 30 an entry signal indicating the artist's intention to apply for the audition, along with the artist's identification data, comment and sampler contents applicable to the category in question. At this point, the artist's terminal device 10 sends the artist's address, telephone number, e-mail address and the like for identifying the artist, together with the artist's bank account data for use in entry fee payment.

In step S4, the server device 30 registers the artist who has entered for the audition. In step S5, the sampler contents of the artists who applied for the audition are posted at the website. As illustrated in FIG. 3, the website lists the registered artists' contents in association with their names or pen names and comments.

In step S6, each viewer at the viewer's terminal device 40 operates the operation unit 45 to designate the relevant URL to access the website in question. The viewer's terminal device 40 in turn displays the website page of FIG. 3 on the display unit 46. When the viewer clicks on the name of any posted artist by operating the operation unit 45, the viewer's terminal device 40 downloads sampler contents of the clicked artist from the server device 30.

More specifically, if the viewer manipulates the operation unit 45 to click on the name of an artist in the category of lyricists, the viewer's terminal device 40 downloads the artist's sampler lyric data for display on the display unit 46. If the viewer operates the operation unit 45 to click on the name of an artist in the category of composers, the viewer's terminal device 40 downloads the artist's sampler score and data representing a performance based on the score. In this case, the viewer's terminal device 40 displays the score on the display unit 46 while having the performance data decoded by the decoder 48. The decoded performance data are converted to analog signals by the D/A converter 49 for acoustic output through the speakers 50. If the viewer clicks on the name of an artist in the category of performers using the operation unit 45, the viewer's terminal device 40 downloads the artist's sampler performance data from the server device 40. The downloaded performance data are decoded by the decoder 48 before being converted to analog signals by the D/A converter 49 for acoustic output through the speakers 50. If the viewer manipulates the operation unit 45 to click on the name of an artist in the category of lyricist-composer-performers, the viewer's terminal device 40 downloads the artist's sampler whole-music data from the server device 30. The downloaded data are decoded by the decoder 48 before being converted to analog signals by the D/A converter 49 for acoustic output through the speakers 50.

In the manner described, each viewer can actually watch and listen to what is being offered by the artists who have entered for the audition. The viewer, based on his or her impression of the artists' offerings and by reading the artists' comments posted on the website, can select the artists to his or her liking.

After deciding on the favorite artists, the viewer operates the operation unit 45 in step S7 to click on a ballot button 82 for each artist selected. The click on the ballot button 82 for a given artist using the operation unit 45 causes the viewer's terminal device 40 to send a ballot signal regarding that artist to the server device 30. Given the ballot signal, the server device 300 increments the number of ballots for the artist in question.

In step S8, the server device 30 judges whether a predetermined period of time has elapsed. If the predetermined period is judged to have passed, step S9 is reached. If the predetermined period is not judged to have elapsed yet, step S8 is repeated.

In step S9, the server device 30 counts the number of ballots for each of the artists involved. In step S10, the server device 30 checks to see if each artist has reached a threshold ballot count. For the artists whose ballot count has exceeded the threshold, step S11 is reached; for those whose ballet count has failed to reach the threshold, step S12 is reached.

In step S11, the server device 30 accepts as successful entrants those artists whose ballot count from the audition exceeded the threshold. In step S12, the server device 30 rejects those artists whose ballot count was below the threshold. In step S13, the server device 30 sends an acceptance notice to the terminal device 10 of each artist accepted at the audition. The acceptance notice tells the successful entrants that they are now qualified to get viewers' requests to write lyrics, compose melodies or otherwise produce music on their behalf. In step S14, the server device 30 sends a rejection notice to the terminal devices 10 of those artists who failed the audition. Given the acceptance or rejection notice, each artist who entered for the audition is able to know his or her success or failure at the audition.

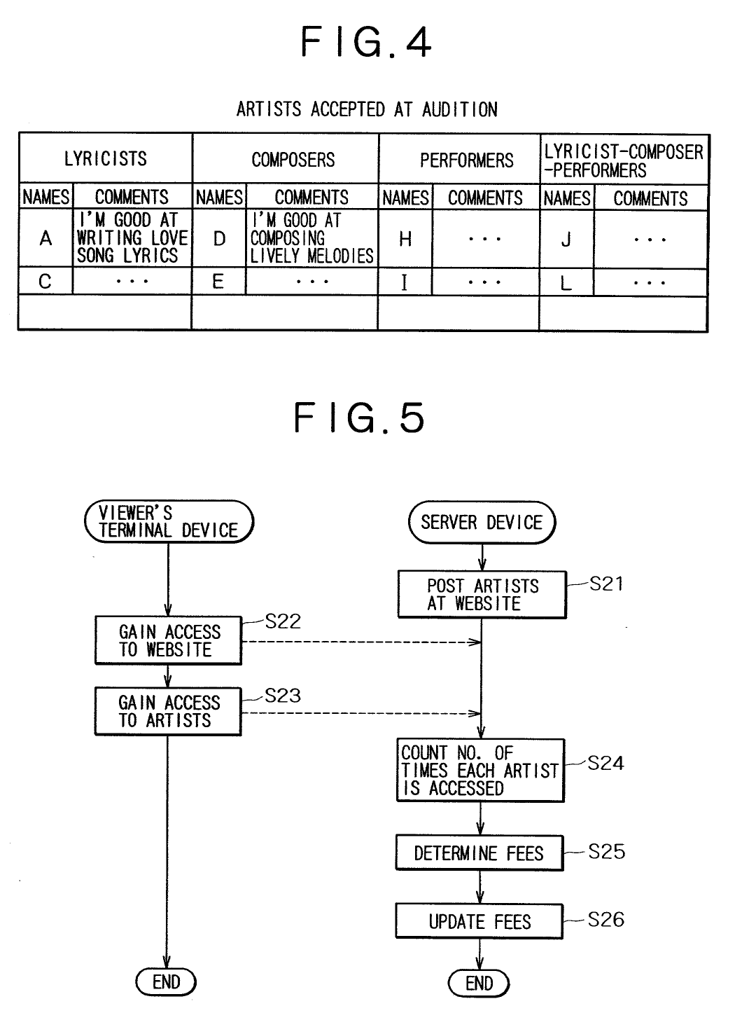

In step S16, the server device 30 announces the results of the audition at the website as depicted in FIG. 4. Illustratively, of the artists A through L entered for the audition as shown in FIG. 3, artists A, C, D, E, H, I, J and L are judged to have exceeded the threshold ballot count in step S10 and are thus selected as successful entrants as shown in FIG. 4. The selected artists are now allowed to receive viewers' requests to produce original pieces of music to the viewers' liking.

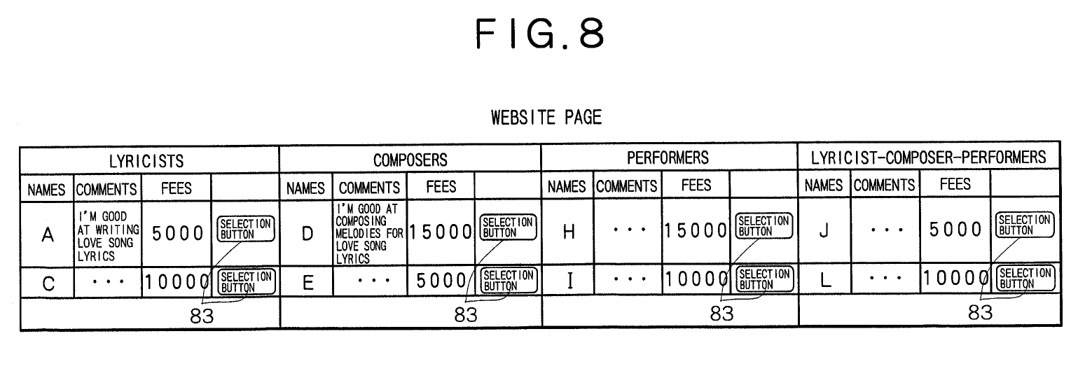

In step S21 of FIG. 5, the server device 30 posts the sampler contents of the successful entrants along with their names or pen names at the website as shown in FIG. 8. The sampler contents disclosed at the website for viewers' evaluation may or may not be the same as those submitted to the audition. After their success in the audition, the artists may upload new contents to the server device 30.

In step S22, the viewer at the viewer's terminal device 40 manipulates the operation unit 45 to designate the relevant URL for gaining access to the website in question. The viewer's terminal device 40 in turn displays the website pages on the display unit 46.

In step S23, the viewer clicks on a selection button 83 for the name or pen name of a given artist using the operation unit 45. The click on the button 83 causes the viewer's terminal device 40 to download the sampler contents of the corresponding artist posted. With the contents downloaded, the viewer can actually watch and listen to what is being offered by the artists who may subsequently be commissioned to produce a piece of music on the viewer's behalf. The viewer, based on his or her impression of the artists' offerings and by reading the artists' comments posted on the website, can select the artists to his or her liking.

In step S24, the server device 30 counts the number of times each of the artists involved has been accessed for sampler contents. In step S25, the server device 30 determines the fee for each artist in accordance with his or her access count.

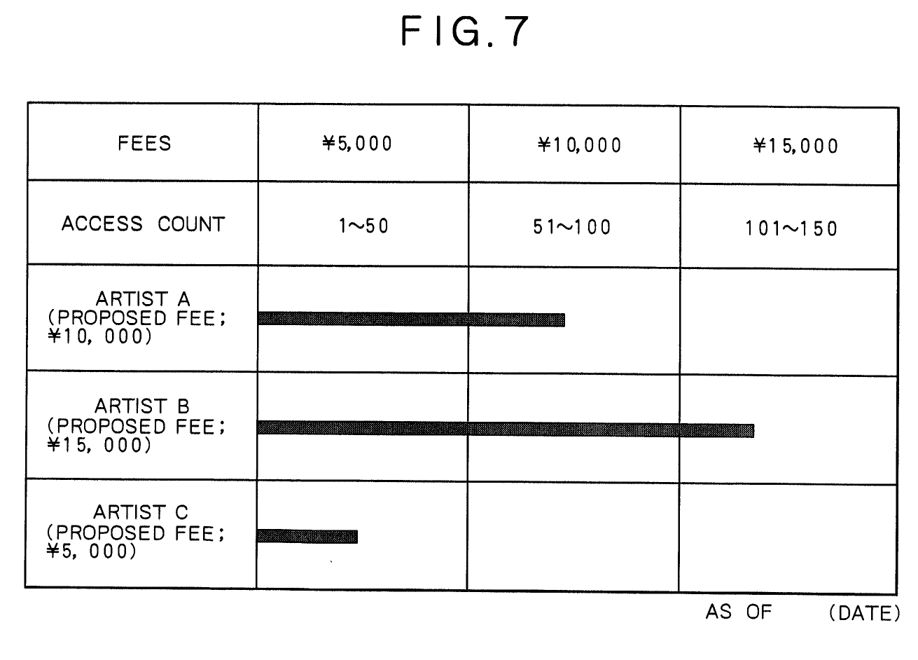

More specifically, as shown in FIG. 7, the server device 30 sees to it that the larger the number of times an artist has been accessed, the higher the fee for that artist. Illustratively, artists who have been accessed by 1 to 50 viewers may be set each for a fee of ¥5,000; artists accessed by 51 to 100 viewers may be set for a fee of ¥10,000 each; and artists accessed by 101 to 150 viewers may each be set for a fee of ¥15,000. In the example of FIG. 7, artist A who were accessed by between 51 and 100 viewers is assigned the fee of ¥10,000; artist B accessed by between 101 and 150 viewers is assigned the fee of ¥15,000; and artist C accessed by between 1 and 50 viewers is assigned the fee of ¥5,000.

The fees associated with the different viewer count brackets are not limited to the example of FIG. 7. Alternatively, the fees may be varied depending on the number of viewers who have actually requested each artist to produce pieces of music. As another alternative, the same fees may be set for all artists regardless of the access count or the actual request count.

In step S26, the server device 30 updates the fees for the artists in accordance with the number of times each artist has been accessed. The fee for a given artist is raised automatically if the access count for that artist has reached the next higher access count bracket. For example, the moment the access count for artist A has exceeded 101, the artist's fee is raised from the initially determined ¥10,000 to ¥15,000. The higher the access count, the greater the interest the viewers have in the artist in question. The server device 30 then raises the fee for that artist in expectation of higher revenues.

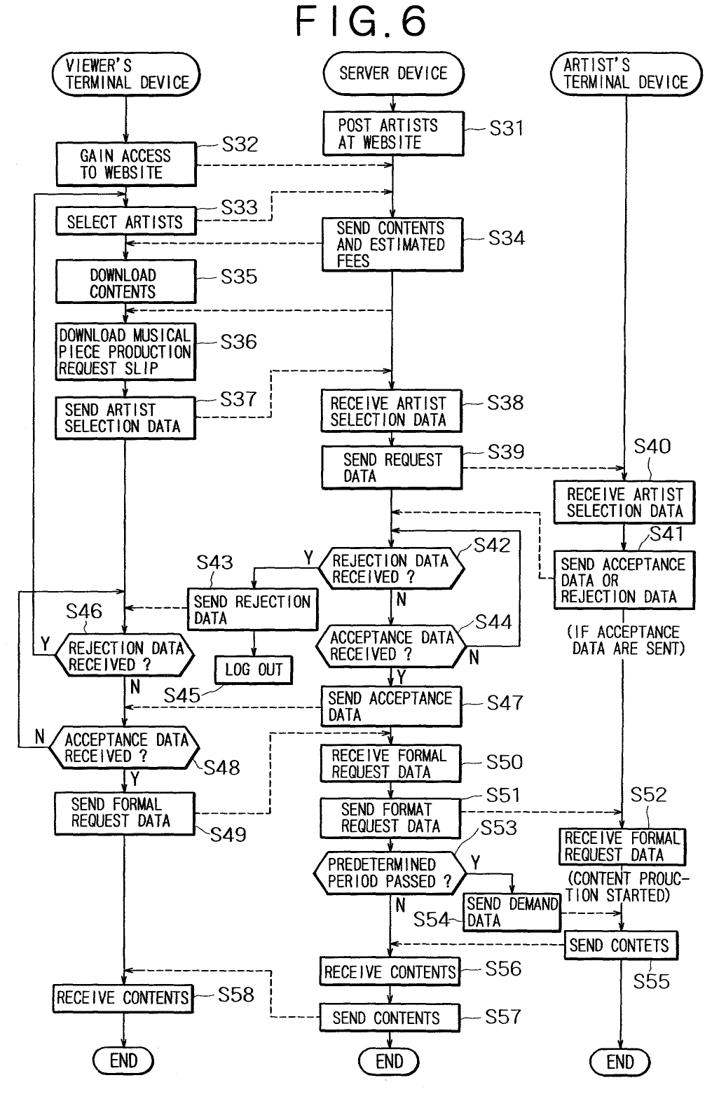

Described below with reference to FIG. 6 is a process in which a viewer after browsing the website selects a favorite artist or artists and requests them to produce a piece of music over the Internet 2. The process comes to an end when a completed piece of music is delivered to the viewer.

In step S31 of FIG. 6, the server device 30 discloses a website page that lists the artists accepted at the audition as described in reference to FIG. 4. The website page, as illustrated in FIG. 8, contains fields of categories made up of “lyrists,” “composers,” “performers” and “lyricist-composer-performers” listing the accepted artists applicable to each category. The categorized artist fields are each furnished with columns of names, comments, fees, and selection buttons 83. Any one of the selection buttons 83 may be clicked to select the corresponding artist by a viewer manipulating the operation unit 45. The website further explains a flow of steps from the time a viewer commissions an artist or artists to produce a piece of music until the completed piece of music is delivered to the viewer.

In step S32, the viewer at the viewer's terminal device 40 operates the operation unit 45 to designate the appropriate URL for access to the website. Specifying the URL causes the viewer's terminal device 40 to download the website page for display on the display unit 46 as depicted in FIG. 8. The viewer's terminal device 40 downloads at least the sampler contents of the artists and their identification data.

In step S33, the viewer may click on the selection button 83 for a given artist by manipulating the operation unit 45. The click on the button 83 causes the viewer's terminal device 40 to send to the server device 30 a selection signal indicating that the artist in question has been selected by the viewer.

In step S34, the server device 30 sends to the viewer's terminal device 40 the sampler contents of the artists corresponding to the selection signals, along with data about estimated fees to be paid to the artists if these artists are subsequently commissioned to produce music on the viewer's behalf.

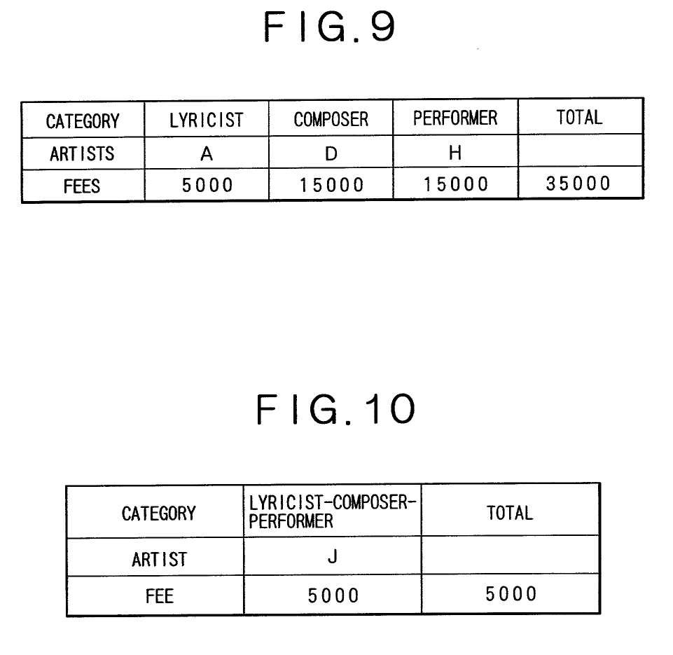

The fees are estimated as follows: upon receipt from the viewer's terminal device 40 of selection signals corresponding to artist A in the lyricist category, artist D in the composer category, and artist H in the performer category, the server device 30 causes the control unit 36 to estimate the total sum of fees to be paid to the three artists, as shown illustratively in FIG. 9. Specifically, the control unit 36 ascertains that the predetermined fees are ¥5,000 for artist A, ¥15,000 for artist D and ¥15,000 for artist H, and transmits the totaled estimate of ¥35,000 to the viewer's terminal device 40.

If an artist in the lyricist-composer-performer category is commissioned to produce a piece of music, that artist will do everything (writing lyrics, composing a melody and performing the song) all by himself or herself. That means the predetermined fee for that artist alone constitutes the estimated total fee. Illustratively, if artist J is commissioned to produce a piece of music, the predetermined fee of ¥5,000 for that artist is transferred by the control unit 36 to the viewer's terminal device 40 as the estimated total fee.

In step S35, the viewer's terminal device 40 receives the sampler contents of the selected artists and the estimated sum data from the server device 30.

More specifically, suppose that a viewer manipulating the operation unit 45 clicks on the selection buttons 83 for an artist in the lyricist category, an artist in the composer category, and an artist for the performer category. In that case, the viewer's terminal device 40 downloads the sampler data produced by the selected artists, i.e., lyric data by the lyricist, melody data (e.g., score and performance) by the composer, and performance data by the performer. Illustratively, the lyrics and the score are displayed on the display unit 46 while any performance submitted optionally by the composer and the performance produced by the performer are output through the speakers 50 of the viewers' terminal device 40.

The viewer then actually watches and listens to the artists' sampler contents. The viewer, based on his or her impression of the artists' offerings and by reading the artists' comments posted on the website, can select the artists to his or her liking.

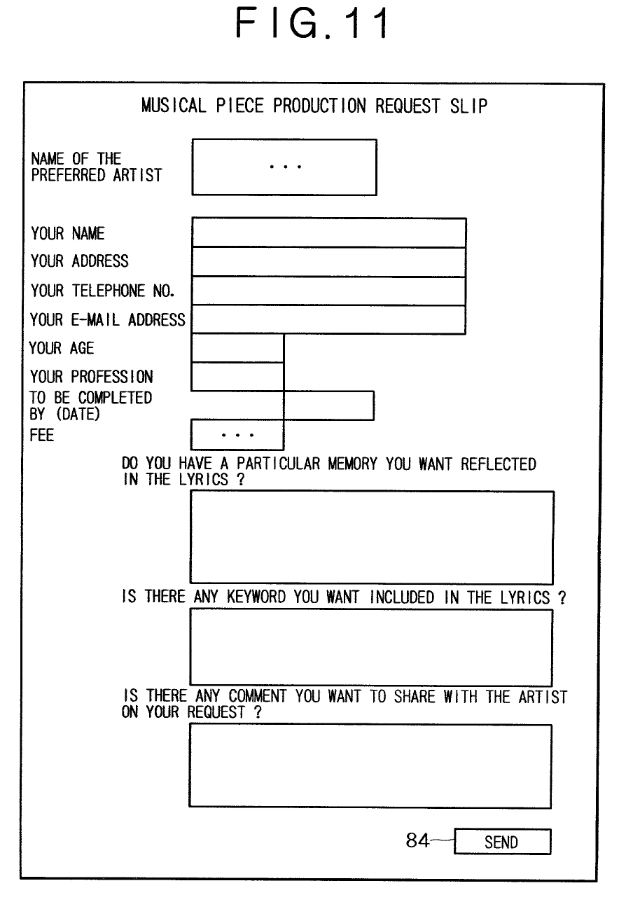

After selecting the artists, the viewer may request them to produce a piece of music illustratively as follows: in step S36 of FIG. 6, the viewer at the viewer's terminal device 40 downloads a musical piece production request slip shown in FIG. 11 from the server device 30. The viewer makes necessary entries into the request slip through the operation unit 45. As illustrated in FIG. 11, the musical piece production request slip has fields that accommodate the names of favorite artists and the fees to be paid to the artists requested to produce music. The artist name field was filled earlier with artists' names by the server device 30 based on the selection signals sent from the viewer's terminal device 40 to the server 30 in step S33. When downloaded by the viewer's terminal device 40, the musical piece production request slip is displayed on the display unit 46, with the artist name field showing the names of the artists selected by the viewer and the request fee field indicating the total fee to be paid to the artists.

The musical piece production request slip also includes fields in which to enter the viewer's name, address, telephone number, age and profession; fields in which a desired delivery date may be specified and the fee involved is indicated; and fields where the viewer may detail his or her specific request, i.e., any particular memory the viewer may want reflected in the lyrics, any keyword the viewer may want included in the lyrics, and any message the viewer may want to share with the artists. Entries into these fields of the musical piece production request slip are made by the viewer manipulating the operation unit 45.

After making the necessary entries into the request slip, the viewer in step S37 clicks on a send button 84 of the request slip shown in FIG. 11 by operating the operation unit 45. In turn, the viewer's terminal device 40 sends the musical piece production request slip together with all its entries to the server device 30 as artist selection data. The server device 30 in standby mode receives the filled-out slip in step S38. Specifically, the viewer's terminal device 40 sends to the server device 30 three kinds of data: the requesting viewer's identification data, the identification data about the artists selected by the viewer, and the viewer's request data destined for the selected artists. Receipt of these data by the server device 30 completes the process of the viewer requesting the artists to produce music on the viewer's behalf.

In step S39, the server device 30 sends the request data to the terminal devices 10 of the artists selected by the viewer and identified by the musical piece production request slip that came from the viewer's terminal device 40. The request data include any particular memory the viewer may want reflected in the lyrics, any keyword the viewer may want included in the lyrics, and any message the viewer may want to share with the artists, all detailed as mentioned above in the musical piece production request slip.

In step S40, the relevant artists' terminal devices 10 in standby mode receive the request data and have them displayed on the display unit 16. For example, upon receipt from the viewer of a request for commissioning a lyricist, a composer and a performer to produce music, the server device 30 sends the request data to the terminal device 10 of each of the artists involved. In the case of a request from the viewer for commissioning a lyricist-composer-performer to produce music, the server device 30 sends the request data only to that artist's terminal device 10. Given the request data, the artist or artists are able to know what is requested of them. In turn, based on the request data received from the server device 30, each artist involved decides whether or not to accept the commission.

In step S41, each artist at the artist's terminal device 10 may send to the server device 30 acceptance data indicating that the artist agrees to accept the commission proposed by the viewer as notified by the server device 30. Alternatively, the artist may send rejection data from the artist's terminal device 10 to the server device 30 saying that the artist declines to accept the proposed commission.

In step S42, the server device 30 judges whether the rejection data have been received from any of the artists' terminal devices 10 involved. Upon receipt of the rejection data, step S43 is reached; if no rejection data are judged received, step S44 is reached.

Upon receipt of the rejection data, the server device 30 in step S43 forwards the rejection data to the viewer's terminal device 40 in accordance with the requesting viewer's identification data received in step S38. The rejection data tell the viewer the selected artist in question declined to accept the proposed commission. Step S43 is followed by step S45 in which the process is terminated. In step S46, the viewer's terminal device 40 judges whether the rejection data have been received. Upon receipt of the rejection data, step S33 is reached again to afford the viewer another attempt to select an artist. If no rejection data are judged received, step S48 is reached.

If in step S42 the server device 30 does not receive any rejection data from the artists' terminal devices 10, the server device 30 goes to step S44. In step S44, the server device 30 ascertains whether the acceptance data have been received from the artists' terminal devices 10. Upon receipt of the acceptance data, step S47 is reached. In step S47, the server device 30 forwards the acceptance data to the viewer's terminal device 40 in accordance with the requesting viewer's identification data received in step S38. If no acceptance data are judged received in step S44, step S42 is reached again.

In step S48, the viewer's terminal device 40 judges whether the acceptance data have been received from the server device 30. Upon receipt of the acceptance data, step S49 is reached. If no acceptance data are judged received in step S48, step S46 is reached again. With the acceptance data received by the terminal device 40, the viewer is able to know that the selected artists have agreed to accept the viewer's commission. In step S49, the viewer operates the terminal device 40 to send to the server device 30 formal request data for formally requesting the artists to produce music on the viewer's behalf. At this point, the viewer's terminal device 40 also sends the viewer's bank account data for use in paying the fees to the artists.

In step S50, the server device 30 receives the formal request data from the viewer's terminal device 40. In step S51, the server device 30 forwards only the formal request data to the artists' terminal devices 10 involved. In step S52, each artist's terminal device 10 involved receives the formal request data from the server device 30. In turn, the artists in question send acknowledge data to the server device 30 and start producing music contents (lyrics, melody, whole-music).

For example, suppose that a viewer has commissioned a lyricist, a composer and a performer to produce a piece of music. In that case, the lyricist first writes lyrics based on the request data and uploads the lyric data from the artist's terminal device 10 to the server device 30. The composer then composes a melody to go with the lyrics based on the request data and uploads the melody data from the artist's data terminal 10 to the server device 30. The server device 30 sends the uploaded lyric and melody data to the performer's terminal device 10. Upon receipt of the lyric and melody data at the artist's terminal device 10, the performer produces a whole piece of music based on the downloaded lyric and melody data as well as on the request data from the server device 30.

In another example, if a viewer has commissioned a lyricist-composer-performer to produce music, the artist will do everything by himself or herself (writing lyrics, composing a melody and performing the song) based on the request data.

In step S53 of FIG. 6, the server device 30 checks to see if the music data have been received from the artists' terminal devices 10 involved. More specifically, the server device 30 judges whether the music data have been received from the artists' terminal devices 10 by a predetermined date. This step is taken to make sure that the music data are transmitted to the requesting viewer's terminal device 40 by the desired deadline specified by the viewer in the musical piece production request slip shown in FIG. 11. If the music data are not judged received from the artists' terminal devices 10 by the predetermined date, step S54 is reached. In step S54, the server device 30 sends demand data such as a notice saying “Your delivery is overdue” to the terminal device 10 of the tardy artist taking on the commission from the viewer. Such demand data are used to remind the artists to complete their work within a predetermined period for delivery to the viewer by a due date. Obviously, several days before the deadline, the artists' terminal devices 10 may be sent demand data such as a notice saying “Your delivery is coming due.”

With the work finished, the artist in step S55 sends the completed music data to the server device 30. In step S56, the server device 30 receives the music data. In step S57, the server device 30 forwards the music data that came from the artist's terminal device 10 to the viewer's terminal device 40. In step S58, the viewer's terminal device 40 receives the music data produced and delivered by the commissioned artist or artists. The viewer saves the delivered music data on the HDD 41 or into an external storage unit connected to the drive 51. To listen to the music data, the viewer reads the data from the storage unit 41 or other appropriate locations into the RAM 65 and gets the data decoded by the decoder 48. The decoded music data are converted to analog signals by the D/A converter 49 for acoustic output through the speakers 50. This allows the viewer to enjoy the music data produced by the commissioned artist or artists on the viewer's behalf.

If the viewer does not like the delivered music data, the viewer may return the music data together with a comment on what is desired to be modified to the artist's terminal device 10 via the server device 30. The music data may thus be submitted to the artist for modification.

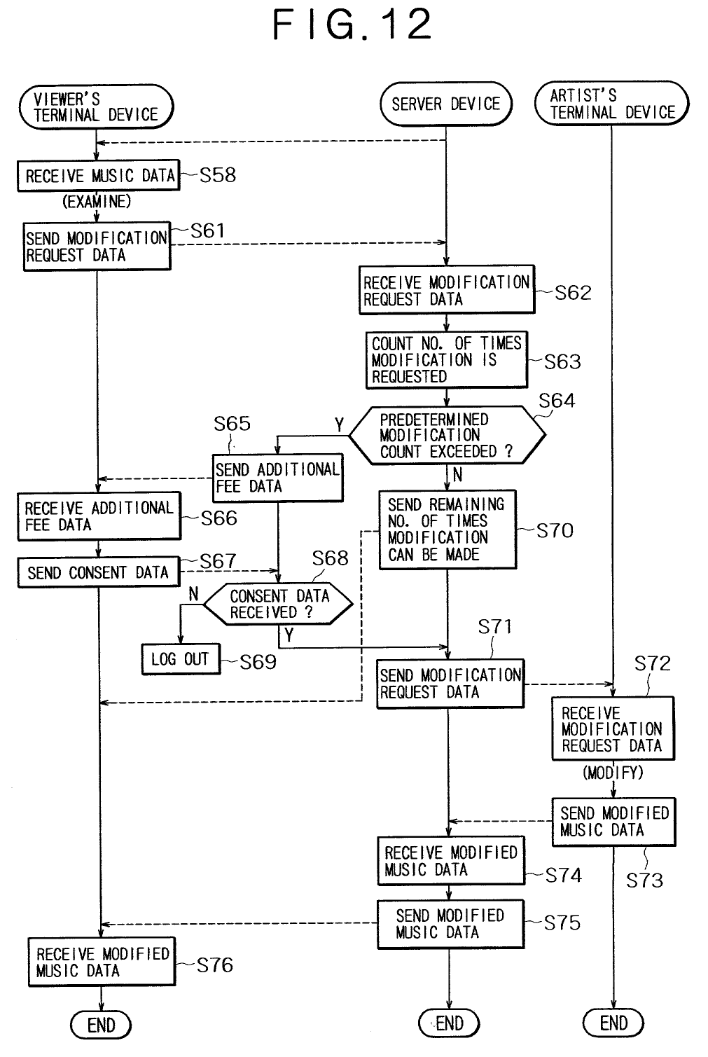

More specifically, as shown in FIG. 12, the viewer's terminal device 40 receives the music data from the server device 30 in step S58. The viewer test-listens to the music data that are output through the speakers 50 of the terminal device 40. If the viewer finds something amiss with the delivered music data, the viewer writes a comment such as “Could you modify such and such parts into such and such forms?” Such modification request data are sent to the server device 30 by the viewer operating the viewer's terminal device 40.

In step S62, the server device 30 receives the modification request data. In step S63, the server device 30 counts the number of times modification request data bound for the specific artist have been received. Specifically, in step S63, the server device 30 increments the number of times the viewer has asked the artist in question to modify the music data. In step S64, the server device 30 judges whether the modification request data receipt count has exceeded a predetermined threshold count. If the threshold count is judged exceeded, step S65 is reached. If the threshold count is not judged exceeded yet, step S70 is reached.

If in step S64 the modification request data receipt count is judged to have exceeded the threshold count, the server device 30 goes to step S65 in which the server sends additional fee data to the viewer asking the latter to pay an additional fee. The server device 30 thus informs the viewer that every time modification of the music data is requested, an additional fee needs to be paid.

In step S66, the viewer's terminal device 40 receives the additional fee data prompting the viewer to determine whether or not to request the artist to modify the music data in view of the additional fee to be paid. If the viewer decides to have the music data modified for the additional fee, the viewer sends additional payment acceptance data from the viewer's terminal device 40 to the server device 30.

In step S68, the server device 30 judges whether the additional payment acceptance data have been received from the viewer's terminal device 40. If the acceptance data are judged received, step S71 is reached. If the acceptance data are not judged received, step S69 is reached in which the process is terminated. With the process brought to an end, the modification request data from the viewer's terminal device 40 will be kept from getting forwarded to the artist's terminal device 10, and the music data will not be modified by the artist.

In step S64 the server device 30 judges whether the number of times the modification request data have been received has not exceeded the predetermined threshold count yet. If the threshold count is not judged exceeded, step S70 is reached in which the server device 30 sends remaining modification count data to the viewer's terminal device 40 telling the viewer how many more times the viewer can request the artist to modify the music data. Upon receipt of the count data at the viewer's terminal device 40, the viewer is thus able to know the remaining available modification request count.

In step S71, the server device 30 forwards the modification request data to the artist's terminal device 10. If the music data the viewer wants to be modified pertain to the lyricist, composer and performer, then the modification request data are sent to the respective artists' terminal devices 10. On the basis of the modification request data received, the lyricist, the composer and the performer modify the lyrics, melody and performance respectively. If the music data desired to be modified pertain to the lyricist-composer-performer, the modification request data are sent to that artist's terminal device 10.

In step S72, the terminal device 10 of each artist involved receives the modification request data. The artist modifies the music data according to the modification request data. Upon completion of the modification, the artist sends the modified music data from the artist's terminal device 10 to the server device 30 in step S73.

In step S74, the server device 30 receives the modified music data. In step S75, the server device 30 forwards the modified music data that came from the artist's terminal device 10 to the requesting viewer's terminal device 40. In step S76, the viewer's terminal device 40 receives the music data modified and delivered by the commissioned artist or artists. The viewer saves the modified music data thus delivered on the HDD 41 or into the external storage unit connected to the drive 51. To listen to the modified music data, the CPU 47 reads the data from the HDD 41 or other appropriate locations into the RAM 65 and gets the data decoded by the decoder 48. The decoded music data are converted to analog signals by the D/A converter 49 for acoustic output through the speakers 50. This allows the viewer to listen to the music data produced and modified by the commissioned artist or artists on the viewer's behalf.

If the viewer again wants the music data to be modified by the artists, step S61 and subsequent steps are repeated.

In the manner described, the viewer may have the commissioned music data modified to his or her satisfaction.

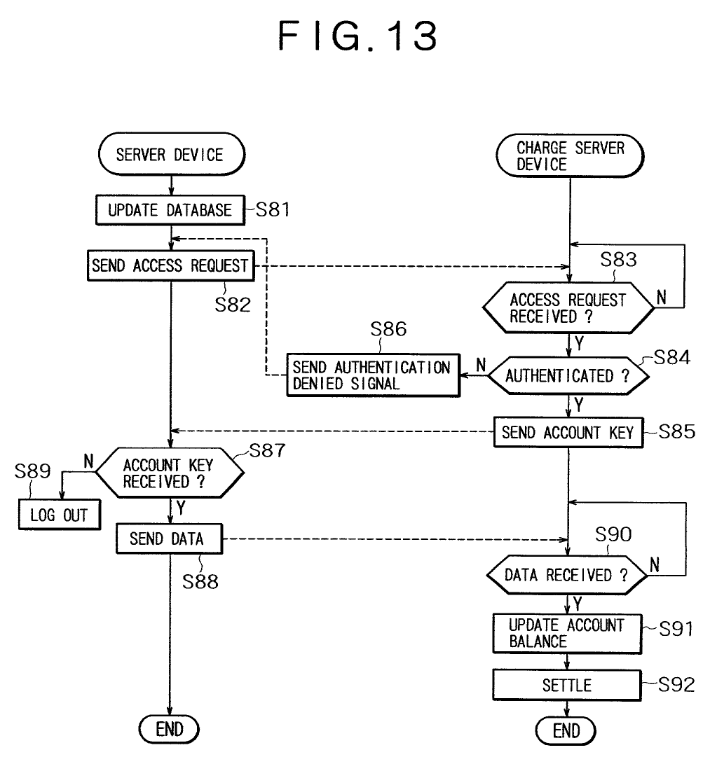

Described below with reference to FIG. 13 are steps taken to settle entry fees to be paid by artists entering for an audition, fees to be paid by viewers to artists commissioned to produce music on the viewers' behalf, and additional fees to be paid to artists requested by viewers to modify the music data the artists produced and delivered to the viewers.

In step S81 of FIG. 13, the server device 30 updates a database in the storage unit 31 based on the fees paid by artists entering for an audition, on the fees paid by viewers to artists commissioned to produce music, and on the additional fees paid by the viewers requesting the commissioned artists to modify the delivered music data over the predetermined count. Specifically, when any artist who entered for an audition pays an entry fee, the server device 30 transfers the payment to the server's administrator. When fees are paid by any viewer for requesting an artist or artists to produce music or to modify the music data produced and delivered by the latter, the server device 30 transfers the payment to the server's administrator and to the artists involved in a suitably allocated manner.

In step S82, the server device 30 sends its server ID and a request for access to the bank accounts of the artist and the viewer involved to the charge server device 60 via the leased line 3.

In step S83, the charge server device 60 in access request reception standby mode receives from the server device 30 the server ID and the request for access to the bank accounts of the artist and viewer involved. In step S84, the charge server device 60 carries out an authentication process based on the server ID.

It is assumed here that the viewer and artist previously submitted their bank account data to the inventive system for designated use and that the charge server device 60 has server IDs of this system registered in correspondence with the viewers' and artists' bank account data. In that setup, the charge server device 60 matches the server ID received from the server device 30 against the server ID data held in the storage unit 63 for authentication purposes. If the received server ID is authenticated, the charge server device 60 goes to step S85; if authentication is denied, the charge server device 60 goes to step S86. In step S86, an authentication-denied signal is sent to the server device 30, whereupon the server device 30 terminates its process.

In step S85, the charge server device 60 transmits a key to the viewer's account and a key to the artist's account to the server device 30. In step S87, the server device 60 receives the keys to the viewer' and the artist's bank accounts. In step S88, the server device 30 sends to the charge server device 60 such data as the viewer's bank account key, artist's bank account key, a key to the server's bank account registered beforehand in the server device 30, profit data for the server device 30, payment data or profit data regarding the artist in question, and payment data about the viewer involved. After transmitting the above data, the server device 30 terminates its process. In step S87, the server device 30 checks to see if the data above have been received. If the data are not judged received, step S89 is reached in which the server 30 disconnects from, say, the Internet.

In step S90, the charge server device 60 is ready to receive the viewer's bank account key, the artist's bank account key and other data from the server device 30. If the data are judged received from the server device 30 in step S90, the charge server device 60 goes to step S91 to update the database accordingly in the storage unit 63.

More specifically, the charge server device 60 gains access to the viewer's bank account management data using the viewer's bank account key. Based on the viewer's payment data, the charge server device 60 updates the dates, past transactions and the balance of account in the viewer's bank account management data. Using the bank account key of the artist commissioned by the viewer to produce music, the charge server device 60 also accesses the artist's bank account management data to update the dates, past transactions and the balance of account in the management data.

Where the artist has entered for the audition, the charge server device 60 accesses the artist's bank account management data using the artist's bank account key. Based on the entry fee payment, the charge server device 60 updates the dates, past transactions and the balance of account in the artist's bank account management data.

Using the server's bank account key, the charge server device 60 further accesses the server's bank account management data to update the dates, past transactions and the balance of account in the management data according to the server's profit.

With the bank account management data thus updated, the charge server device 60 goes to step S92. In step S92, the charge server device 60 communicates with the banking center 70 to settle the accounts involved at the banks that are suitably identified. That is, the updated account management data are reflected exactly in the banks' account data. When the bank accounts are settled and updated as described, the charge server device 60 terminates its process.

The inventive data transmission-reception system described above allows viewers each possessing a more or less general-purpose computer to easily request artists to produce music on the viewers' behalf, and permits the artists also in possession of a similar ordinary computer to accept viewers' commissions to produce music for a profit. When a viewer wants to request artists to produce music on his or her behalf, the viewer gains access from the terminal device 40 to an appropriate website from which the artists' sampler contents are downloaded for trial. Having read the lyrics and having listened to the melodies, the viewer may eventually decide on some preferred artists and commission them to produce music to the viewer's linking. Furthermore, this data transmission-reception system allows unevenly gifted artists, e.g., those who are good at composing melodies but not at writing lyrics or vice versa, to take part in auditions and eventually offer their services. In addition, this system provides business opportunities to amateurs and professionally motivated but little known artists who have yet to sign a contract with any record companies or agencies.

The artist's terminal device 10, the server device 30 and the viewer's terminal device 40 are each constituted by a general-purpose computer. A program or programs constituting the series of steps described above may be installed upon use into each of these computers for execution, carried by a suitable program storage medium such as an optical disc, a magneto-optical disc, a magnetic disc, or an IC card accommodating a semiconductor memory. The storage medium is loaded into an external storage unit connected to the drives 21, 37 and 51 of the computers. Operating the drives 21, 37 and 51 causes the computer programs to be retrieved from the external storage unit and installed onto the HDDs 11, 31 and 41 for execution. The programs may alternatively be installed into the computers via the Internet 2, over a LAN (local area network) or via a satellite link.

The music contents produced by artists are transmitted and received rapidly over the Internet 2 when compressed by such methods as ATRAC3 (Adaptive Transform Acoustic Coding 3; trademark), MPEG-2AAC (Moving Picture Experts Group 2 Advanced Audio Coding; trademark), MP3 (MPEG-1 Audio Layer 3; trademark), TwinVQ (Transform-Domain Weighted Interleave Vector Quantization; trademark), MS Audio (WMA: Windows Media Audio; trademark), or Ogg Vorbis (trademark).

The data transmission-reception system 1 according to the invention was shown handling music data as contents. However, this is not limitative of the invention. Alternatively, the system may deal with data representative of paintings, photos, movies, games and other items. Where moving pictures such as movies or games are handled as contents, the data may be compressed by such methods as MPEG4 or MPEG7 for rapid transmission and reception over the network.

As described, the system and method according to the invention allow users to readily commission content providers who are typically artists to produce contents on the users' behalf. The artists are able to gain profit from the contents they have been requested to produce. Before asking any content providers to produce contents, the user may gain access from his or her terminal device to the server device to browse sampler contents offered by the artists. In so doing, the user may decide on favorite artists and request them to produce contents to the user's liking. Any artists (amateur or little known) may easily take part in the setup of the inventive system.

As many apparently different embodiments of this invention may be made without departing from the spirit and scope thereof, it is to be understood that the invention is not limited to the specific embodiments thereof except as defined in the appended claims.

What is claimed is:

1. A data communication system comprising:
first terminal devices for transmitting first contents and IDs of information providers providing said first contents;
a server device for receiving said first contents and the information provider IDs from said first terminal devices and for storing the received first contents and information provider IDs onto storing means; and
second terminal devices which display on displaying means information provider information including at least said first contents and said information provider IDs transmitted from said server device; which allow users to select desired items of said information provider information displayed on said displaying means; and which transmit to said server device information provider IDs corresponding to the user-selected items of said information provider information, along with user IDs of said users;
wherein said server device transmits to said first terminal devices request data corresponding to the information provider IDs sent from said second terminal devices;
wherein said first terminal devices transmit second contents corresponding to said request data to said server device; and
wherein said server device transmits said second contents to the second terminal devices corresponding to said user IDs.

2. A data communication system according to claim 1, wherein said server device comprises counting means for counting the number of times each of said information provider IDs has been transmitted from said second terminal devices.

3. A data communication system according to claim 2, wherein said server device comprises linking means for linking to a publicly accessible website the information provider information corresponding to the information provider IDs of which the transmission count each has exceeded a threshold value.

4. A data communication system according to claim 3, wherein said publicly accessible website, under management by said server device, has any of lyric data, melody data and performance data produced and uploaded thereto by the information providers corresponding to said information provider IDs.

5. A data communication system according to claim 4, wherein said second terminal devices transmit to said server device the information provider IDs corresponding to the data selected by users from among a lyric data group, a melody data group and a performance data group produced by said information providers posted at said publicly accessible website on said displaying means, along with user IDs of said users; and
wherein said counting means of said server device counts the number of times each of said information provider IDs has been transmitted from said second terminal devices.

6. A data communication system according to claim 5, wherein said server device comprises content production request fee setting means for setting fees to be paid to each of said information providers for producing a commissioned content in accordance with the transmission count of each information provider counted by said counting means; and
wherein said server device transmits request data including the content production request fees to the first terminal devices corresponding to the information provider IDs transmitted by said second terminal devices.

7. A data communication system according to claim 6, wherein said content production request fee setting means of said server device sets higher content production request fees for information providers the higher the ID transmission count thereof counted by said counting means.

8. A data communication system according to claim 4, wherein said second terminal devices transmit to said server device a plurality of information provider IDs selected by users based on the lyric data, melody data and performance data produced by said information providers posted at said publicly accessible website, along with user IDs of said users;
wherein said server device transmits request data to a plurality of first terminal devices corresponding to said plurality of information provider IDs sent from said second terminal devices;
wherein said plurality of first terminal devices transmit to said server device music data as said second contents produced by the information providers corresponding to said plurality of first terminal devices; and
wherein said server device transmits said music data received from said first terminal devices to said second terminal devices corresponding to said user IDs.

9. A data communication system according to claim 3, wherein said publicly accessible website, under management by said server device, has music data produced and uploaded thereto by the information providers corresponding to said information provider IDs.

10. A data communication system according to claim 9, wherein said second terminal devices transmit to said sever device the information provider IDs corresponding to the music data selected by users from among a music data group produced by said information providers posted at said publicly accessible website, together with user IDs of said users; and
wherein said counting means of said server device counts the number of times each of said information provider IDs has been transmitted from said second terminal devices.

11. A data communication system according to claim 9, wherein said first terminal devices transmit to said server device more music data produced as said second contents on the basis of said request data.

12. A data communication system according to claim 8, wherein said server device transmits confirmation data to said first terminal devices corresponding to the information provider IDs sent from said second terminal devices, said confirmation data asking the information providers at said first terminal devices whether they agree to the request from said second terminal devices, said server device transmitting agreement data to said second terminal devices if said information providers at said first terminal devices have agreed to said request from said second terminal devices; and
wherein said second terminal devices, in response to said agreement data, transmit formal content production request data to said first terminal devices via said server device.

13. A data communication system according to claim 1, wherein said server device transmits demand data to said first terminal devices if said second contents are not received from said first terminal devices upon elapse of a predetermined time period.

14. A data communication system according to claim 8, wherein said second terminal devices transmit to said server device modification request data requesting modification of music data, along with the information provider IDs corresponding to the information providers who produced the music data in question, as well as user IDs of the requesting users;
wherein said server device transmits said modification request data from said second terminal devices to said first terminal devices corresponding to said information provider IDs;
wherein said first terminal devices, in response to said modification request data, return modified music data to said server device; and
wherein said server device transmits said modified music data returned from said first terminal devices to said second terminal devices corresponding to said user IDs.

15. A data communication system according to claim 6, wherein said first terminal devices transmit to said server device information provider bank account identification data for identifying the bank accounts of said information providers;
wherein said second terminal devices transmit to said server device user bank account identification data for identifying the bank accounts of said users; and
wherein said server device, based on said content production request fees, establishes amounts to be transferred to the bank accounts identified by said information provider bank account identification data, and amounts to be withdrawn from the bank accounts identified by said user bank account identification data, said server device further transmitting the established amounts together with the bank account identification data associated therewith to an external charge server.

16. A server device comprising:
communicating means for communicating with first terminal devices of information providers providing first contents, and with second terminal devices of users requesting said information providers to produce second contents;
storing means for storing said first contents and IDs of said information providers transmitted from said first terminal devices; and
controlling means for causing said communicating means:
to transmit to said second terminal devices information provider information including said first contents and the information provider IDs received from said first terminal devices;
to receive information provider IDs selected by users of said second terminal devices along with user IDs of said users;
to transmit request data to the first terminal devices corresponding to the selected information provider IDs;
to receive from said first terminal devices more second contents corresponding to said request data; and
to transmit said second contents to the second terminal devices corresponding to said user IDs.

17. A server device according to claim 16, further comprising counting means for counting the number of times each of said information provider IDs has been transmitted from said second terminal devices.

18. A server device according to claim 17, further comprising linking means for linking to a publicly accessible website the information provider information corresponding to the information provider IDs of which the transmission count each has exceeded a threshold value.

19. A server device according to claim 18, wherein said publicly accessible website, under management by said controlling means, has any of lyric data, melody data and performance data produced and uploaded thereto by the information providers corresponding to said information provider IDs.

20. A server device according to claim 19, wherein said controlling means causes said communication means to receive the information provider IDs corresponding to the data selected by users at said second terminal devices from among a lyric data group, a melody data group and a performance data group produced by said information providers posted at said publicly accessible website, along with user IDs of said users; and
wherein said counting means counts the number of times each of said information provider, IDs has been transmitted from said second terminal devices.

21. A server device according to claim 20, further comprising content production request fee setting means for setting fees to be paid to each of said information providers for producing a commissioned content in accordance with the transmission count of each information provider counted by said counting means;
wherein said controlling means causes said communicating means to transmit request data including the content production request fees to the first terminal devices corresponding to the information provider IDs transmitted by said second terminal devices.

22. A server device according to claim 21, wherein said content production request fee setting means sets higher content production request fees for information providers the higher the ID transmission count thereof counted by said counting means.

23. A server device according to claim 19, wherein said controlling means causes said communicating means:
to receive from said second terminal devices a plurality of information provider IDs selected by users based on the lyric data, melody data and performance data produced by said information providers posted at said publicly accessible website, along with user IDs of said users;
to transmit request data to a plurality of first terminal devices corresponding to said plurality of information provider IDs sent from said second terminal devices;
to receive from said first terminal devices music data as said second contents produced by a plurality of information providers corresponding to said plurality of first terminal devices; and
to transmit said music data that came from said first terminal devices to said second terminal devices corresponding to said user IDs.

24. A server device according to claim 18, wherein said publicly accessible website, under management by said controlling means, has music data produced and uploaded thereto by the information providers corresponding to said information provider IDs.

25. A server device according to claim 24, wherein said controlling means causes said communicating means to receive at said second terminal devices the information provider IDs corresponding to the music data selected by users from among a music data group produced by said information providers posted at said publicly accessible website, together with user IDs of said users; and
wherein said counting means counts the number of times each of said information provider IDs has been transmitted from said second terminal devices.

26. A server device according to claim 24, wherein said controlling means causes said communicating means to receive from said first terminal devices more music data produced as said second contents on the basis of said request data.

27. A server device according to claim 23, wherein said controlling means causes said communicating means:
to transmit confirmation data to said first terminal devices corresponding to the information provider IDs sent from said second terminal devices, said confirmation data asking the information providers at said first terminal devices whether they agree to the request from said second terminal devices, said communicating means further transmitting agreement data to said second terminal devices if said information providers at said first terminal devices have agreed to said request from said second terminal devices; and
to transmit, in response to said agreement data, formal content production request data coming from said second terminal devices to said first terminal devices.

28. A server device according to claim 16, wherein said controlling means causes said communicating means to transmit demand data to said first terminal devices if said second contents are not received from said first terminal devices upon elapse of a predetermined time period.

29. A server device according to claim 23, wherein said controlling means causes said communicating means:
to receive from said second terminal devices modification request data requesting modification of music data, along with the information provider IDs corresponding to the information providers who produced the music data in question, as well as user IDs of the requesting users;
to transmit said modification request data from said second terminal devices to said first terminal devices corresponding to said information provider IDs;
to receive modified music data returned from said first terminal devices in response to said modification request data; and
to transmit said modified music data returned from said first terminal devices to said second terminal devices corresponding to said user IDs.

30. A server device according to claim 21, wherein said controlling means causes said communicating means:
to receive from said first terminal devices information provider bank account identification data for identifying the bank accounts of said information providers;
to receive from said second terminal devices user bank account identification data for identifying the bank accounts of said users; and
to establish, based on said content production request fees, amounts to be transferred to the bank accounts identified by said information provider bank account identification data, and amounts to be withdrawn from the bank accounts identified by said user bank account identification data, said communicating means further transmitting the established amounts together with the bank account identification data associated therewith to an external charge server.

31. An information processing terminal device comprising:
storing means for storing first contents and information provider IDs;
communicating means for transmitting said first contents and said information provider IDs from said storing means to a server device; and
controlling means for causing said communicating means:
to receive via said server device request data from other information processing terminal devices identified by information provider IDs sent from said other information processing terminal devices; and
to transmit to said server device second contents corresponding to said request data.

32. An information processing terminal device according to claim 31, wherein said server device manages a publicly accessible website that has any of lyric data, melody data and performance data produced and uploaded thereto by the information providers corresponding to said information provider IDs; and
wherein said controlling means causes said communicating means to receive said request data from said other information processing terminal devices via said server device based on the information provider IDs selected by users at said other information processing terminal devices upon browsing the uploaded data at the website.

33. An information processing terminal device according to claim 32, wherein said controlling means causes said communicating means:
to receive from said other information processing terminal devices said request data based on a plurality of information provider IDs selected by said user based on the lyric data, melody data and performance data produced by said information providers posted at said publicly accessible website; and
to transmit to said server device music data as said second contents produced by said plurality of information providers corresponding to said request data.

34. An information processing terminal device according to claim 31, wherein said publicly accessible website, under management by said server device, has music data produced and uploaded thereto by the information providers corresponding to said information provider IDs; and
wherein said controlling means causes said communicating means to receive via said server devise said request data from said other information processing terminal devices in accordance with the information provider IDs selected by the users at said other information processing terminal devices based on the uploaded music data.

35. An information processing terminal device according to claim 34, wherein said controlling means causes said communicating means to transmit to said server device more music data produced as said second contents on the basis of said request data.

36. An information processing terminal device according to claim 33, wherein said controlling means causes said communicating means:
to receive from any of said other information processing terminal devices confirmation data asking the information provider at said other information processing terminal device whether said information provider agrees to the request from the other information processing terminal device;
to transmit agreement data to said other information processing terminal device via said server device in the event of an affirmative response to said confirmation data by said information provider; and
to receive via said server device formal content production request data from said other information processing terminal device from which said agreement data have been received.

37. An information processing terminal device according to claim 33, wherein said controlling means causes said communicating means:
to receive from said server device modification request data requesting modification of music data sent from any of said other information processing terminal devices, said modification request data being identified by an information provider ID; and
to return modified music data to said server device in accordance with said modification request data.

38. An information processing terminal device according to claim 31, wherein said controlling means causes said communicating means to transmit to said server device information provider bank account identification data for identifying the bank accounts of said information providers.

39. An information processing terminal device comprising:
displaying means for displaying information provider information sent from a server device, said information provider information including at least first contents and IDs of information providers providing said first contents;
selecting means for allowing users to select at least one item of said information provider information displayed on said displaying means;
communicating means for transmitting to said server device request data including information provider IDs corresponding to the items of said information provider information which are selected by users through said selecting means, along with user IDs of said users; and
controlling means for causing said communicating means to receive from said server device second contents corresponding to said request data.

40. An information processing terminal device according to claim 39, wherein said server device manages a publicly accessible website that has any of lyric data, melody data and performance data produced and uploaded thereto by the information providers corresponding to said information provider IDs.

41. An information processing terminal device according to claim 40, wherein said controlling means causes said communicating means to transmit to said server device the information provider IDs corresponding to the data selected by users from among a lyric data group, a melody data group and a performance data group produced by said information providers posted at said publicly accessible website displayed on said displaying means, together with user IDs of said users.

42. An information processing terminal device according to claim 41, wherein said controlling means causes said communicating means:
to transmit to said server device a plurality of information provider IDs selected by users based on the lyric data, melody data and performance data produced by said information providers posted at said publicly accessible website, along with user IDs of said users; and
to receive from said server device the music data produced by a plurality of information providers corresponding to said plurality of information provider IDs.

43. An information processing terminal device according to claim 39, wherein said publicly accessible website, under management by said server device, has music data produced and uploaded thereto by the information providers corresponding to said information provider IDs.

44. An information processing terminal device according to claim 43, wherein said controlling means causes said communicating means to transmit to said server device the information provider IDs corresponding to the music data selected by users from among a music data group produced by said information providers posted at said publicly accessible website displayed on said displaying means, together with user IDs of said users.

45. An information processing terminal device according to claim 44, wherein said controlling means causes said communicating means to receive via said server device more music data produced as said second contents on the basis of said request data.

46. An information processing terminal device according to claim 39, wherein said controlling means causes said communicating means:
to transmit via said server device confirmation data to any other information processing terminal device corresponding to an information provider ID, asking the information provider identified by the ID whether or not to agree to produce said second contents as requested;
to receive agreement data from said other information processing terminal device via said server device in the event of an affirmative response to said confirmation data by said information provider; and
to transmit via said server device formal content production request data to said other information processing terminal in accordance with said agreement data.

47. An information processing terminal device according to claim 42, wherein said controlling means causes said communicating means:
to transmit to said server device modification request data requesting modification of music data to any other information processing terminal device corresponding to the information provider who produced said music, along with the information provider ID of said information provider and the user ID of the requesting user; and
to receive via said server device modified music data returned from said other information processing terminal device corresponding to said information provider ID.

48. An information processing terminal device according to claim 39, wherein said controlling means causes said communicating means to transmit to said server device user bank account identification data for identifying the bank accounts of said users.

49. A data communication method for use with a data communication system including first terminal devices, a server device, and second terminal devices, said data communication method comprising the steps of:
allowing said first terminal devices to transmit to said server device first contents and IDs of information providers providing said first contents;
allowing said second terminal devices to display information provider information including at least said first contents and the information provider IDs transmitted from said server device;
allowing said second terminal devices to transmit to said server device information provider IDs corresponding to items of said information provider information which are selected by users, together with user IDs of said users;
allowing said server device to transmit to said first terminal devices request data corresponding to the information provider IDs sent from said second terminal devices;
allowing said first terminal devices to transmit second contents corresponding to said request data to said server device; and
allowing said server device to transmit said second contents to the second terminal devices corresponding to said user IDs.

50. A data communication method for use with a data communication system including first terminal devices and second terminal devices, said data communication method comprising the steps of:
transmitting to said second terminal devices information provider information including first contents and IDs of information providers providing said first contents upon receipt of the information from said first terminal devices;
receiving information provider IDs selected by users of said second terminal devices along with user IDs of said users;
transmitting request data to the first terminal devices corresponding to the selected information provider IDs;
receiving from said first terminal devices second contents corresponding to said request data; and
transmitting said second contents to the second terminal devices corresponding to said user IDs.

51. A data communication method for use with an information processing terminal device, said data communication method comprising the steps of:
transmitting to a server device first contents and IDs of information providers providing said first contents;
receiving via said server device request data from other information processing terminal devices identified by the information provider IDs sent from said other information processing terminal devices; and
transmitting to said server device second contents corresponding to said request data.

52. A data communication method for use with an information processing terminal device, said data communication method comprising the steps of:
displaying information provider information sent from a server device, said information provider information including at least first contents and IDs of information providers providing said first contents;
allowing users to select at least one item of the displayed information provider information;
transmitting to said server device request data including information provider IDs corresponding to the items of said information provider information which are selected by users, along with user IDs of said users; and
receiving from said server device second contents corresponding to said request data.

53. A storage medium which stores a computer-controllable data communication program for use with a data communication system including first terminal devices and second terminal devices, said data communication program comprising the steps of:
transmitting to said second terminal devices information provider information including first contents and IDs of information providers providing said first contents upon receipt of the information from said first terminal devices;
receiving information provider IDs selected by users of said second terminal devices along with user IDs of said users;
transmitting request data to the first terminal devices corresponding to the selected information provider IDs;
receiving from said first terminal devices second contents corresponding to said request data; and
transmitting said second contents to the second terminal devices corresponding to said user IDs.

54. A storage medium which stores a computer-controllable data communication program for use with an information processing terminal device, said data communication program comprising the steps of:
transmitting to a server device first contents and IDs of information providers providing said first contents;
receiving via said server device request data from other information processing terminal devices identified by the information provider IDs sent from said other information processing terminal devices; and
transmitting to said server device second contents corresponding to said request data.

55. A storage medium which stores a computer-controllable data communication program for use with an information processing terminal device, said data communication program comprising the steps of:
displaying information provider information sent from a server device, said information provider information including at least first contents and IDs of information providers providing said first contents;
allowing users to select at least one item of the displayed information provider information;
transmitting to said server device request data including information provider IDs corresponding to the items of said information provider information which are selected by users, along with user IDs of said users; and
receiving from said server device second contents corresponding to said request data.
